(19) United States
(12) Patent Application Publication
(10) Pub. No.: US 2017/0168437 A1
(43) Pub. Date: Jun. 15, 2017

(54) IMAGE FORMING APPARATUS

(71) Applicant: KYOCERA Document Solutions Inc., Osaka (JP)

(72) Inventor: Kozo Tao, Osaka (JP)

(21) Appl. No.: 15/373,081

(22) Filed: Dec. 8, 2016

(30) Foreign Application Priority Data
Dec. 14, 2015 (JP) 2015-243015

(51) Int. Cl. G03G 15/00; G03G 15/20

(52) U.S. Cl. CPC G03G 15/2053

(57) ABSTRACT

This image forming apparatus includes: a plurality of sheet accommodating portions each including a sheet placement portion on which a sheet is placed; a lifting/lowering portion configured to lift and lower the sheet placement portion; an image forming portion configured to form an image on the sheet supplied from each sheet accommodating portion; and an engine control portion configured to control the image forming portion on the basis of inputted print data. The engine control portion causes the lifting/lowering portion to lift the sheet placement portion to a predetermined sheet feed possible position in response to reception of the type of the sheet, and after the image formation by the image forming portion is finished, the engine control portion causes the lifting/lowering portion to lower the sheet placement portion to a predetermined original position.

### INCORPORATION BY REFERENCE

This application is based upon and claims the benefit of priority from the corresponding Japanese Patent Application No. 2015-243015 filed on Dec. 14, 2015, the entire contents of which are incorporated herein by reference.

### BACKGROUND

The present disclosure relates to an image forming apparatus for forming an image on a sheet.

Some of image forming apparatuses such as a printer or a multifunction peripheral include, aside from a main control portion for executing an image process and the like, an engine control portion for executing an image formation process to form an image on a sheet. In the image forming apparatus of this type, the main control portion executes a so-called interpreter process for converting image data inputted from a personal computer or the like, to print data, and then inputs the print data to the engine control portion. Then, the engine control portion controls an image forming portion on the basis of the print data, to form an image on a sheet. The following feature is known: rotational driving of a polygon mirror of the image forming portion is started before an image formation step is started, thus reducing the required time for the image formation process.

### SUMMARY

An image forming apparatus according to one aspect of the present disclosure includes a plurality of sheet accommodating portions, a lifting/lowering portion, an image forming portion, an engine control portion, a data processing portion, and a sheet type notifying portion. The sheet accommodating portions each include a sheet placement portion on which a sheet is placed. The lifting/lowering portion is configured to lift and lower the sheet placement portion. The image forming portion is configured to form an image on the sheet supplied from each sheet accommodating portion. The engine control portion is configured to control the image forming portion on the basis of inputted print data. The data processing portion is configured to convert inputted image data to the print data and output the print data to the engine control portion. The sheet type notifying portion is capable of, before the print data is outputted to the engine control portion, specifying a type of a sheet to be used in image formation based on the image data, and notifying the engine control portion of the type of the sheet. The engine control portion causes the lifting/lowering portion to lift the sheet placement portion to a predetermined sheet feed possible position in response to reception of the type of the sheet, and after the image formation by the image forming portion is finished, the engine control portion causes the lifting/lowering portion to lower the sheet placement portion to a predetermined original position.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a diagram showing the configuration of an image forming apparatus according to an embodiment of the present disclosure.

FIG. 2 is a block diagram showing the system configuration of the image forming apparatus according to the embodiment of the present disclosure.

FIG. 3 is a timing chart showing an example of a print control process executed by the image forming apparatus according to the embodiment of the present disclosure.

FIG. 4 is a timing chart showing an example of a print control process executed by an image forming apparatus according to a comparative example.

### DETAILED DESCRIPTION

Hereinafter, embodiments of the present disclosure will be described with reference to the accompanying drawings. The following embodiments are examples in which the present disclosure is embodied, and do not limit the technical scope of the present disclosure.

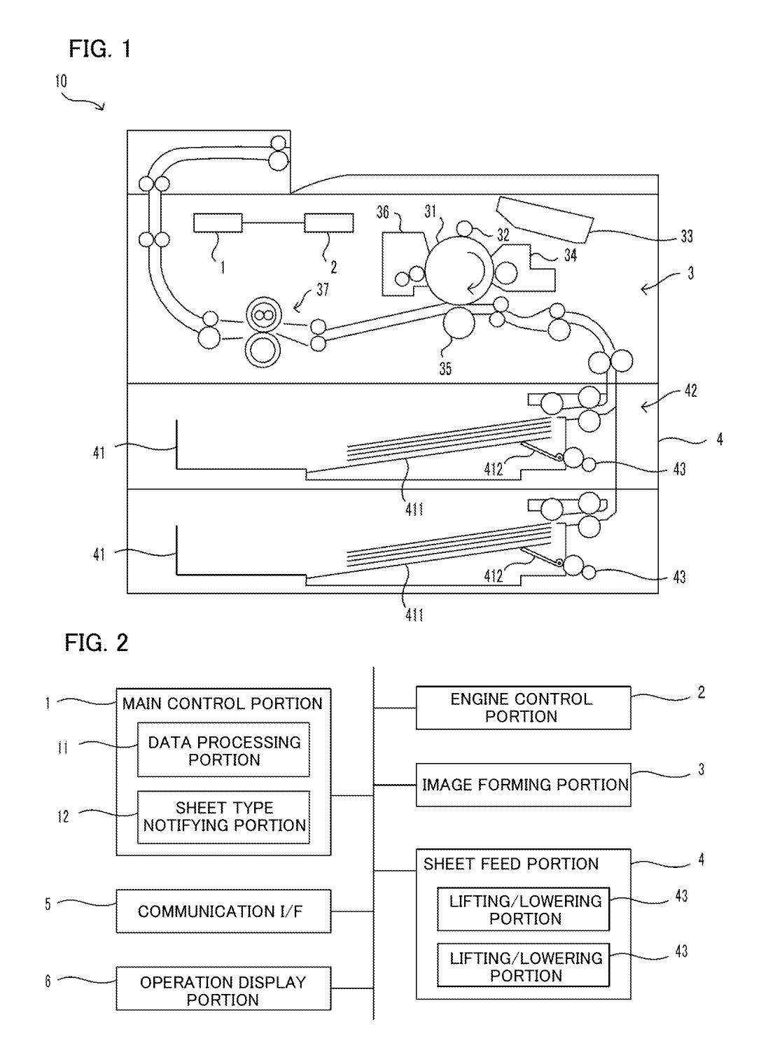

As shown in FIG. 1 and FIG. 2, an image forming apparatus 10 includes a main control portion 1, an engine control portion 2, an image forming portion 3, a sheet feed portion 4, a communication I/F 5, an operation display portion 6, and the like. Specifically, the image forming apparatus 10 is a printer capable of executing an image formation process for forming an image on a sheet on the basis of inputted image data. A facsimile apparatus, a copy machine, a multifunction peripheral, and the like are also examples of the image forming apparatus according to the present disclosure.

The communication I/F 5 is a communication interface for executing a communication process with various communication devices such as a personal computer, a portable terminal, and a facsimile apparatus, in accordance with a predetermined communication protocol. Specifically, the communication I/F 5 is capable of executing a data reception process for receiving image data from the communication device. The operation display portion 6 includes: a display portion such as a liquid crystal display for displaying various types of information; and an operation portion such as an operation button or a touch panel for receiving a user's operation.

The main control portion 1 and the engine control portion 2 each include a CPU, a RAM, a ROM, an EEPROM (registered trademark), and the like, and execute various processes by the CPU in accordance with control programs and various data stored in the ROM or the EEPROM.

For example, the main control portion 1 executes a process for converting the image data to print data, and outputs the converted print data to the engine control portion 2. Meanwhile, the engine control portion 2 controls the image forming portion 3 and the sheet feed portion 4 on the basis of the print data inputted from the main control portion 1, to feed a sheet from the sheet feed portion 4 to the image forming portion 3 and execute an image formation process for forming an image on the sheet by the image forming portion 3. Some or all of the functions of the main control portion 1 and the engine control portion 2 may be realized by an integrated circuit such as DSP or ASIC.

The sheet feed portion 4 includes: a plurality of sheet accommodating portions 41 for accommodating sheets; a conveyance portion 42 for conveying a sheet to the image forming portion 3; and a plurality of lifting/lowering portions 43 corresponding to the plurality of sheet accommodating portions 41. The sheet feed portion 4 is capable of conveying a sheet to be used in image formation by the image forming portion 3, from each sheet accommodating portion 41 to the image forming portion 3 through the conveyance portion 42. The sheet feed portion 4 may include three or more sheet accommodating portions 41.

Each sheet accommodating portion 41 is a sheet feed cassette attachable to and detachable from the sheet feed portion 4 of the image forming apparatus 10. Each sheet accommodating portion 41 includes: a sheet placement portion 411 on which sheets are placed; and a lift mechanism 412 for lifting and lowering the sheet placement portion 411. The sheet placement portion 411 is a flat-plate-shaped member which is also referred to as a lift board.

Each sheet accommodating portion 41 is provided with a cursor member used for regulating movement of sheets, and is capable of accommodating predetermined plural types (e.g., size or orientation) of sheets by the position of the cursor member being adjusted. In the image forming apparatus 10, the engine control portion 2 sets the types of sheets corresponding to the respective sheet accommodating portions 41, in response to a user's operation through the operation display portion 6 or the like, for example. The sheet feed portion 4 may be provided with a detection sensor for detecting the type of sheets on the basis of the position of the cursor member in each sheet accommodating portion 41, and the engine control portion 2 may set the types of sheets corresponding to the respective sheet accommodating portions 41 in accordance with the detection result from the detection sensor. Thus, the engine control portion 2 can specify the sheet accommodating portion 41 that accommodates sheets corresponding to the type of a sheet to be used in image formation by the image forming portion 3.

The sheet placement portion 411 is pivotably supported by the sheet accommodating portion 41, at the rear end side of a sheet to be conveyed by the sheet feed portion 4. In addition, the sheet placement portion 411 is supported so as to be able to be lifted and lowered, by the lift mechanism 412, at the front end side of a sheet to be conveyed by the sheet feed portion 4.

The lift mechanism 412 is a pivoting portion having one end pivotably supported by the sheet accommodating portion 41, and another end supporting the lower part of the sheet placement portion 411. Thus, the lift mechanism 412 can lift and lower the sheet placement portion 411 by pivoting. The lift mechanism 412 may be provided, together with the lifting/lowering portion 43, on the sheet feed portion 4 side, instead of being provided on the sheet accommodating portion 41.

The lifting/lowering portions 43 drive the respective lift mechanisms 412 of the sheet accommodating portions 41, to lift or lower the sheet placement portions 411. Specifically, each lifting/lowering portion 43 has a motor, a gear, and the like, and turns the lift mechanism 412 in both directions to lift and lower the sheet placement portion 411. Specifically, as described above, the engine control portion 2 controls the lifting/lowering portion 43 to lift the sheet placement portion 411 at the start of an image formation process, and controls the lifting/lowering portion 43 to lower the sheet placement portion 411 after the image formation process is finished.

The image forming portion 3 is an image forming portion of an electrophotographic type which includes a photosensitive drum 31, a charging device 32, a light scanning unit 33, a developing device 34, a transfer roller 35, a cleaning device 36, and a fixing device 37, and forms an image on a sheet. Specifically, in the image forming portion 3, on the photosensitive drum 31 (surface to be scanned) charged by the charging device 32, an electrostatic latent image based on image data is formed by the light scanning unit 33 scanning a light beam. Next, in the image forming portion 3, the electrostatic latent image formed on the surface of the photosensitive drum 31 is developed with toner by the developing device 34, and then transferred to a sheet by the transfer roller 35. Thereafter, the toner image transferred to the sheet is melted and fixed on the sheet by the fixing device 37. The surface of the photosensitive drum 31 is cleaned by the cleaning device 36.

By the way, in the image forming apparatus 10, in the case where, after receiving print data from the main control portion 1, the engine control portion 2 selects the sheet accommodating portion 41 to be used in an image formation process based on the print data, control of the lifting/lowering portion 43 that corresponds to the selected sheet accommodating portion 41 cannot be started until the print data is received. Therefore, reduction in the required time for the image formation process might be hindered. In contrast, the image forming apparatus 10 according to the present embodiment enables reduction in the required time for the image formation process.

Specifically, the main control portion 1 includes a data processing portion 11 and a sheet type notifying portion 12. The main control portion 1 functions as the data processing portion 11 and the sheet type notifying portion 12 by the CPU executing a process according to a control program stored in the ROM or the like.

The data processing portion 11 executes an interpreter process for converting image data inputted via the communication I/F 5 from an information processing device such as a personal computer, to print data recognizable by the engine control portion 2, and outputs the print data to the engine control portion 2. Specifically, the data processing portion 11 sequentially converts data per one page included in the image data, to print data, and outputs the print data to the engine control portion 2. A unit of processing by the data processing portion 11 is not limited to page, but, for example, it is also conceivable that data per partial area, such as a predetermined band unit, smaller than one page may be sequentially converted to print data, and then the print data is outputted to the engine control portion 2.

Before conversion of image data to print data by the data processing portion 11 is finished and the print data is transmitted to the engine control portion 2, the sheet type notifying portion 12 specifies the type such as the size or orientation of a sheet to be used in the image formation process based on the image data. Then, before the print data is transmitted to the engine control portion 2, the sheet type notifying portion 12 notifies the engine control portion 2 of the type of the sheet. For example, before conversion of image data to print data by the data processing portion 11 is started or during the conversion, the sheet type notifying portion 12 notifies the engine control portion 2 of the type of the sheet.

Specifically, after having receiving the image data, at the time of converting the image data to the print data, the data processing portion 11 analyzes the image data and determines the type of a sheet to be used in the image formation process. Then, at the time when the data processing portion 11 has determined the type of the sheet to be used in the image formation process based on the image data, the data processing portion 11 notifies the sheet type notifying portion 12 of the type of the sheet. Thus, the sheet type notifying portion 12 can specify the type of the sheet at a time before the conversion to the print data is finished.

Meanwhile, when having received the notification of the type of the sheet from the sheet type notifying portion 12, the engine control portion 2 selects the sheet accommodating portion 41 that accommodates sheets corresponding to the type of the sheet, as a sheet accommodating portion to be used in the image formation process based on the image data. Then, the engine control portion 2 controls the lifting/lowering portion 43 corresponding to the sheet accommodating portion 41, to execute a lift-up process for lifting the sheet placement portion 411 of the sheet accommodating portion 41 to a predetermined sheet feed possible position. For example, the sheet feed possible position is a position at which the upper end of a sheet has contact at a predetermined pressure with a pickup roller used for the sheet feed portion 4 to pick up a sheet in the sheet accommodating portion 41, and such a state is detected using an optical sensor or the like, or detected on the basis of the magnitude of a load applied to the lifting/lowering portion 43.

Thereafter, when the sheet placement portion 411 has been lifted to the sheet feed possible position, the engine control portion 2 controls the sheet feed portion 4 to feed a sheet placed on the sheet placement portion 411 to the image forming portion 3 and convey the sheet to a predetermined standby position. For example, the standby position is a position at which the front end of the sheet reaches a registration roller provided on the upstream side of the photosensitive drum 31 in the image forming portion 3, and the reaching of the sheet to the standby position is detected by a registration sensor provided on the upstream side of the registration roller.

Next, when having received the print data from the main control portion 1, the engine control portion 2 controls the image forming portion 3 on the basis of the print data to form a toner image on the photosensitive drum 31 and starts conveyance of the sheet standing by at the standby position. Thus, an image based on the image data is formed on the sheet. If the sheet has not reached the standby position yet, the engine control portion 2 starts formation of a toner image on the photosensitive drum 31 and conveyance of the sheet after the sheet reaches the standby position.

Then, after the image formation by the image forming portion 3 is finished, the engine control portion 2 controls the lifting/lowering portion 43 to execute a lift-down process for lowering the sheet placement portion 411 of the sheet accommodating portion 41 to a predetermined original position. Specifically, after the image formation by the image forming portion 3 is finished, if a predetermined time has elapsed without the next image formation process being started, the engine control portion 2 lowers the sheet placement portion 411. For example, the original position is a position when the sheet placement portion 411 is supported at the lowest position by the lift mechanism 412, and such a state is detected using an optical sensor or the like, or detected on the basis of the magnitude of a load applied to the lifting/lowering portion 43.

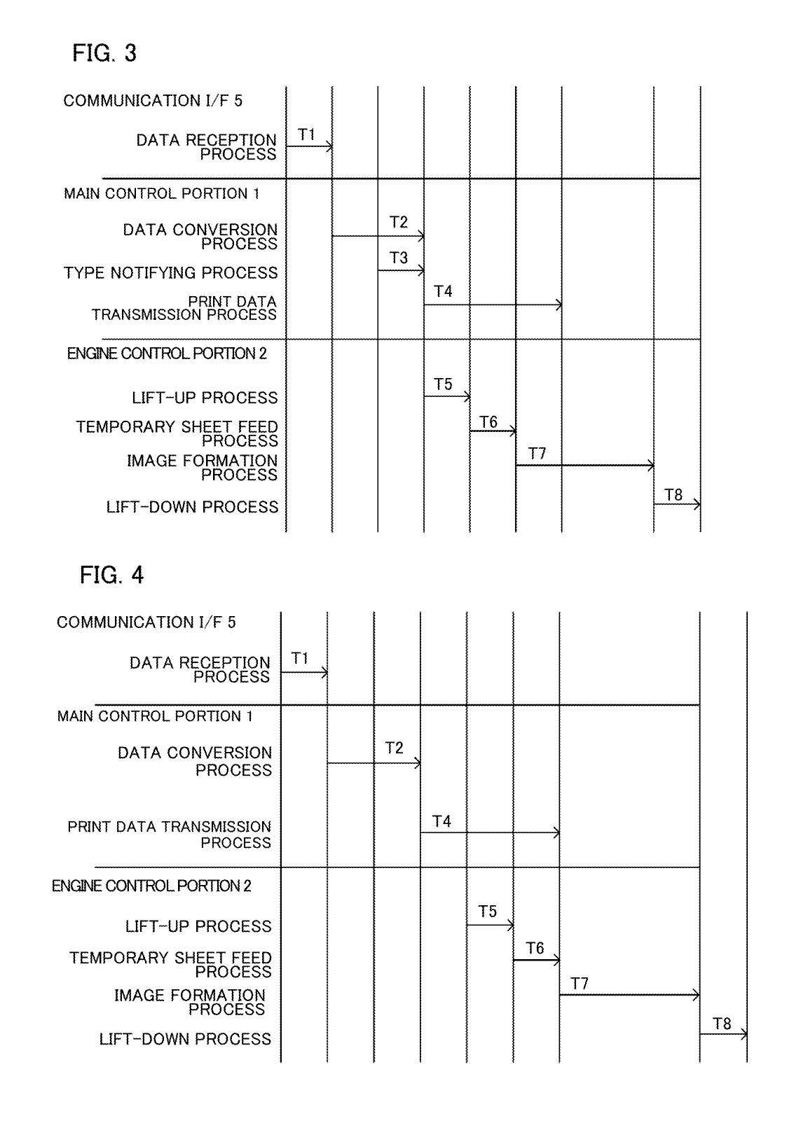

Hereinafter, with reference to FIG. 3, an example of a print control process executed by the main control portion 1 and the engine control portion 2 in the image forming apparatus 10 will be described. The print control process is executed when, for example, a print job including image data is inputted from the communication device to the image forming apparatus 10. It is noted that in FIG. 3, the time progresses from left to right.

First, as shown in FIG. 3, in the image forming apparatus 10, the communication I/F 5 executes a data reception process for receiving image data from the communication device (time T1). Thereafter, in the main control portion 1, the data processing portion 11 executes a data conversion process for converting the image data to the print data (time T2).

Then, in the main control portion 1, the sheet type notifying portion 12 executes a type notifying process for specifying the type of a sheet to be used in the image formation process based on the image data and notifying the engine control portion 2 of the type of the sheet (time T3).

Thereafter, in the main control portion 1, after the conversion of the image data to the print data is finished, the data processing portion 11 executes a print data transmission process for transmitting the print data to the engine control portion 2 (time T4). The timing of starting the print data transmission process is the time when the conversion to the print data per one page is finished, or the time when the conversion to the print data per predetermined partial area smaller than one page is finished.

Meanwhile, at the time when the engine control portion 2 has received the type of the sheet transmitted from the sheet type notifying portion 12, the engine control portion 2 can specify the type of the sheet to be used in the image formation process. Then, in response to the reception of the type of the sheet, the engine control portion 2 selects the sheet accommodating portion 41 that accommodates sheets corresponding to the type of the sheet, and controls the lifting/lowering portion 43 corresponding to the selected sheet accommodating portion 41, to execute the lift-up process (time T5).

Further, at the time when the engine control portion 2 has received the notification of the type of the sheet from the main control portion 1, the engine control portion 2 may start a heating process for heating the fixing device 37 to a predetermined fixation temperature. The main control portion 1 may transmit, to the engine control portion 2, a notification for starting the heating process at the time when the engine control portion 2 has received the image data, and thereafter, may transmit the type of the sheet to the engine control portion 2 at the time when the type of the sheet to be used in the image formation based on the image data has been specified.

Similarly, at the time when the engine control portion 2 has received the notification of the type of the sheet from the main control portion 1, the engine control portion 2 may start a drive process to start rotationally driving a polygon mirror provided in the light scanning unit 33. The main control portion 1 may transmit, to the engine control portion 2, a notification for starting the drive process at the time when the engine control portion 2 has received the image data, and thereafter, may transmit the type of the sheet to the engine control portion 2 at the time when the type of the sheet to be used in the image formation based on the image data has been specified.

Thereafter, as shown in FIG. 3, when the lift-up process for the sheet accommodating portion 41 is finished, the engine control portion 2 executes a temporary sheet feed process for conveying a sheet accommodated in the sheet accommodating portion 41 to the standby position in the image forming portion 3 (time T6).

Then, if the engine control portion 2 has received the print data and also has finished the temporary sheet feed process, the engine control portion 2 starts an image formation process based on the print data. Specifically, the engine control portion 2 forms a toner image on the photosensitive drum 31 and starts conveyance of the sheet standing by at the sheet feed position, thus executing image formation by the image forming portion 3.

Next, when the image formation process has been finished, the engine control portion 2 controls the lifting/lowering portion 43 that corresponds to the sheet accommodating portion 41 used in the image formation process, to execute the lift-down process (time T8).

As described above, in the image forming apparatus 10, before print data is transmitted from the main control portion 1 to the engine control portion 2, the engine control portion 2 is notified of the type of a sheet to be used in an image formation process based on the print data. Therefore, the engine control portion 2 can start, at an early stage, the lift-up process for the sheet accommodating portion 41 that corresponds to the type of the sheet, and can convey the sheet to the standby position in the image forming portion 3. Thus, the image forming apparatus 10 enables reduction in the required time taken from reception of image data until printing on the sheet is finished.

On the other hand, FIG. 4 is a diagram showing a print control process in the case where the type notifying process is not executed by the main control portion 1, as a comparative example. In the comparative example shown in FIG. 4, the type notifying process by the main control portion 1 is not executed, but a notification of the type of the sheet is performed in the print data transmission process. In this case, as shown in FIG. 4, the engine control portion 2 executes the lift-up process after having received the print data. Thus, there is a possibility that start of the lift-up process is delayed and reduction in the required time for the image formation process is hindered.

As another embodiment, in the case where plural types of sheets are used in the image formation process based on image data, the sheet type notifying portion 12 may execute the type notifying process at each of the timings at which the respective types of the sheets are specified during conversion of the image data to the print data.

In the present embodiment, a print job in the case of receiving the image data from the communication device has been described as an example. Besides, also in the case where the image forming apparatus 10 includes an image reading portion for reading image data from a document and the image data read by the image reading portion is inputted, the present disclosure is applicable in the same manner. In this case, in the type notifying process, the main control portion 1 determines the type of the sheet on the basis of a print setting condition made through the operation display portion 6 or the like, and notifies the engine control portion 2 of the type of the sheet.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image forming apparatus comprising:
a plurality of sheet accommodating portions each including a sheet placement portion on which a sheet is placed;
a lifting/lowering portion configured to lift and lower the sheet placement portion;
an image forming portion configured to form an image on the sheet supplied from each sheet accommodating portion;
an engine control portion configured to control the image forming portion on the basis of inputted print data;
a data processing portion configured to convert inputted image data to the print data and output the print data to the engine control portion; and
a sheet type notifying portion capable of, before the print data is outputted to the engine control portion, specifying a type of a sheet to be used in image formation based on the image data, and notifying the engine control portion of the type of the sheet, wherein
the engine control portion causes the lifting/lowering portion to lift the sheet placement portion to a predetermined sheet feed possible position in response to reception of the type of the sheet, and after the image formation by the image forming portion is finished, the engine control portion causes the lifting/lowering portion to lower the sheet placement portion to a predetermined original position.

2. The image forming apparatus according to claim 1, wherein
at a time when the sheet placement portion is lifted to the sheet feed possible position, the engine control portion executes a temporary sheet feed process to feed the sheet placed on the sheet placement portion to a predetermined standby position in the image forming portion, and after the print data is received, the engine control portion starts conveyance of the sheet at the standby position to cause the image forming portion to execute the image formation.

3. The image forming apparatus according to claim 1, wherein
when a predetermined period has elapsed since the image formation by the image forming portion has been finished, the engine control portion causes the sheet placement portion to be lowered.

4. The image forming apparatus according to claim 1, wherein
at a time when the engine control portion has received the notification of the type of the sheet, the engine control portion starts a heating process for a fixing device to melt and fix, on the sheet, a toner image transferred to the sheet.

5. The image forming apparatus according to claim 1, wherein
the engine control portion is notified to start heating, at a time when the image data is inputted to the image forming apparatus, and
in response to reception of the notification of start of heating, the engine control portion starts a heating process for a fixing device to melt and fix, on the sheet, a toner image transferred to the sheet, and in response to reception of the type of the sheet, the engine control portion causes the lifting/lowering portion to lift the sheet placement portion to a predetermined sheet feed possible position.
